(19) United States
(12) Patent Application Publication
(10) Pub. No.: US 2006/0226254 A1
(43) Pub. Date: Oct. 12, 2006

(54) Method for unlocking nozzles of reactors

(76) Inventors: Luis Cerda, Santiago (CL); Alex M. Moyano, Santiago (CL); Domingo Montoya, Santiago (CL); Jose Parraguez, Santiago (CL); Ricardo Amigo, Santiago (CL); Justo Luna, Santiago (CL)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/839,703

(22) Filed: May 6, 2004

(51) Int. Cl. B05B 15/02

(52) U.S. Cl. 239/112; 239/104

(57) ABSTRACT

Method intended to unblock enriched air blow or reaction gases nozzles in reactors or fusion converters for mining industry pyrometallurgy CHARACTERIZED by the injection of discrete air impacts with time intervals regulated to high pressure and rate through the enriched air blow or reaction gases nozzles; thus, the air impacts penetrate into the melting bath of such reactors or converters, producing the breaking of blocking accretions that dug the flow of such a enriched air or gas through the nozzle and forming, because the cooling provoked by the penetration of them, a directed accretion with material of the melting bath which is solidified by the cooling effect, allowing that the production of directed accretion be a natural lengthening of the tube of nozzle from the inner wall of these reactors or converters, and by this way to allow that the O2-enriched air blowing through the nozzle enters deeper in the melting bath, to a distance where breaking waves of this flow are generated far of the wall that has refractory material of the reactors or converters, preventing the earlier erosion of the refractory material and tending to eliminate the possible obstructive accretions that can be formed.

The present patent aplication involves a method and system specially designed to put into practice the procedure intended to unblock the air/gas blow nozzles of reactors or fusion converters in pyrometallurgy of mining industry. Particularly, it is intended to a method and system of injection of high pressure and rate air impacts which inhibit the occurrence of blocking accretions in the inner end of air/gas blow nozzle of a converter or fusion reactor for metallurgy.

### PREVIOUS ART

The occurrence of blocking accretions in O2-enriched air blow nozzles in reactors or fusion converters has a relevant effect on the shelf-life period and the performance of pyrometallurgic facilities in the mining industry, specially the reactors or converters used in the copper industry. These air blow nozzles are used for injecting enriched air under the level of the bath to a moderate pressure, between 15 and 20 psi (1.034 and 1.378 bar), generally in a horizontal position, and configurated by tubes embedded into the refractory material of the reactor or converter.

The discharge of this relatively cold enriched air into the melting bath, which has a temperature near to 1300° C., produces the phenomenon of localized solidification in form of accretions which, because the shapes adopted (see FIG. 1), block progressively the pass area in the inner end of the nozzle, decreasing the flow of enriched air. All of that demands the necessity of a mechanic process of periodical punching in order to eliminate the obstruction and restore the blowing flow.

At the present time, the most used way to eliminate the blocking accretions is by means of a punching bar operated from a machine especially intended for that; for instance, a GASPE machine. This punching bar is a metalic rod which is inserted through the hole situated in the outer end of the blow nozzle.

The punching has the disadvantage that the effect of such a procedure is based in a total or partial mechanical extraction of the accretion. When the sharp end of the punching bar hits such accretions, generally occurs the breaking or splitting of the refractory material which surrounds the inner end of the nozzle. Moreover, the procedure can fracture or even break the tube which is part of the very nozzle. While this occurs, the refractory wall is weaked and therefore the shelf-life of reactor or converter is decreased.

Since the punching bar is introduced visually by an operator who is in a cabin located to a significant distance from each nozzle. From there, the operator must aim each hole of the nozzle with the bar, which involves a long time for introducing and subsequently pulling the bar. By the other side, since the bar contacts the melting bath to temperatures over 1200° C., it is produced geometric deformations and degenerations in the constitution of steel, which is the material that the bar is composed. Thus, the bar looses its thermophysical characteristics and such a deformation occurs. Therefore, when the operator must insert the bar into the next nozzle, if he does not aim correctly to the hole of that nozzle, it is produced a deformation of the sharp end of the hot punching bar. This fact involves a violent detachment of the blocking accretion and dragging with it part of the refractory material adhered.

By the oher side, when the bar is retired from the inner of nozzle, resistance is generated because part of the material from the melting bath is dragged with it. Then, this material stays in the travel of the tube which comprise the nozzle. This material adhered to the inner part of the nozzle tube produces alterations in its structure, like porosities in which a larger accretion will be adhered, provoking an uncontrolled erosion of the very length of the tube which is part of the nozzle.

Considering the problems with the previous art, the present application solves them in a great proportion through an injection system of air impacts to high pressure and rate, which have the tendency to produce a non-obstructive directed accretion.

The advantages of this invention are related with the following: when a high pressure air impact, between 70 and 100 psi (4.82 and 6.89 bar), is injected, the air enters more deeper in the melting bath improving the fusion conditions and decreasing the “splashing” close to the refractory material, preventing its premature erosion by friction. On the other hand, since the accretions inside of the converter and surrounding the internal end of the nozzle are produced after 1 minute of enriched air blowing through the nozzle, the making of a high pressure and rate air impact injection allows to inhibit the formation of an obstructive accretion. On the contrary, as is possible to see in the FIG. 2, it is produced a directed accretion which eliminate automatically one of the causes of the erosion of refractory material.

At the same way, since the fact that a bar or other mechanical element for removing accretions is not used, the dragging of material from melting bath through the tube towards the outside of nozzle and then the tube itself is not prematurely erosioned.

When the directed accretion has been formed, it is obtained a natural lengthening of the nozzle, as shown in the FIG. 2, in a distance “s”, because of which the penetration of enriched air into the melting bath will be deeper and, consequently it will be obtained a better use of the reaction air and an improvement of the reaction kinetics. Therefore, since the enriched air enters to a longer distance from the wall of refractory material, in a zone of the melting bath where already exists surge, the occurrence of obstructive accretions will be eliminated because the very surge tends to remove them which means that it is produced a combination between surge and high pressure and rate air impact.

### A BRIEF DESCRIPTION OF THE FIGURES

FIG. 1: corresponds to a cross section diagram about the formation of obstructive accretions in the inner end of the enriched air blow nozzle.

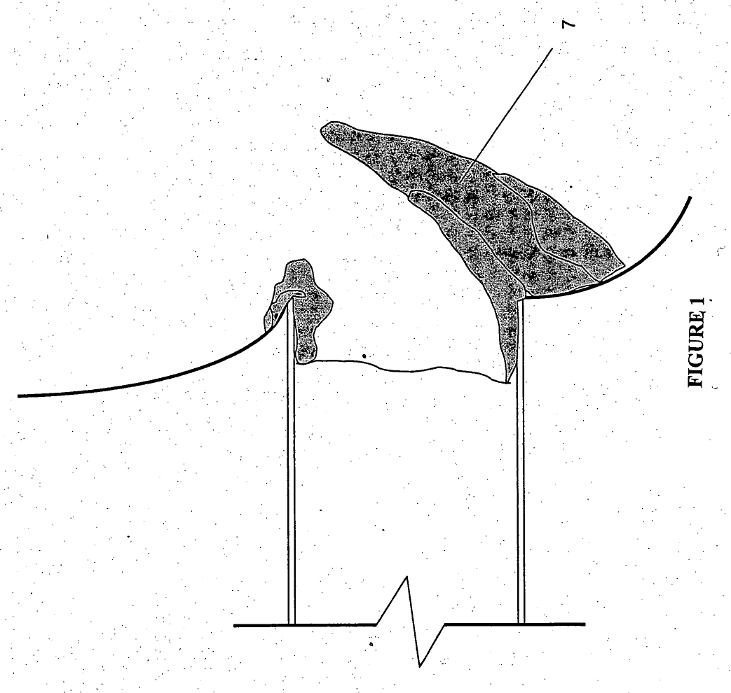

FIG. 2: corresponds to a cross section diagram of the formation of directed accretions in the inner end of the air blow nozzle when it has been applied air impacts according to the performing of the present invention.

FIG. 3: corresponds to a cross section diagram of the configuration of injection system of air impacts from the present invention, located in the air blow nozzle and, in turn, this nozzle located on the casing of a standard converter or reactor.

FIG. 4: corresponds to a cross section diagram of the injection system of air impacts from the present invention.

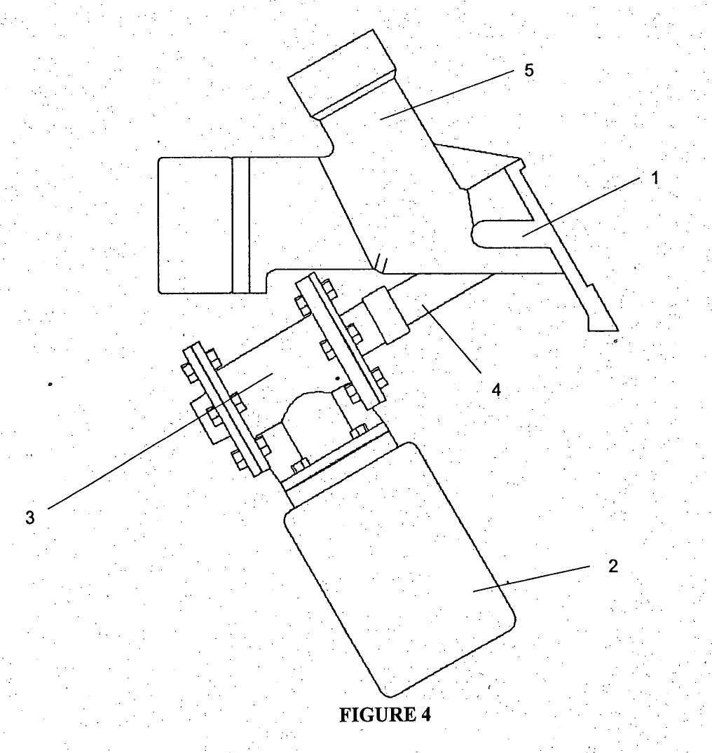

FIG. 5: corresponds to a perspective view, seen from back and from top of the injection system of air impacts from the present invention.

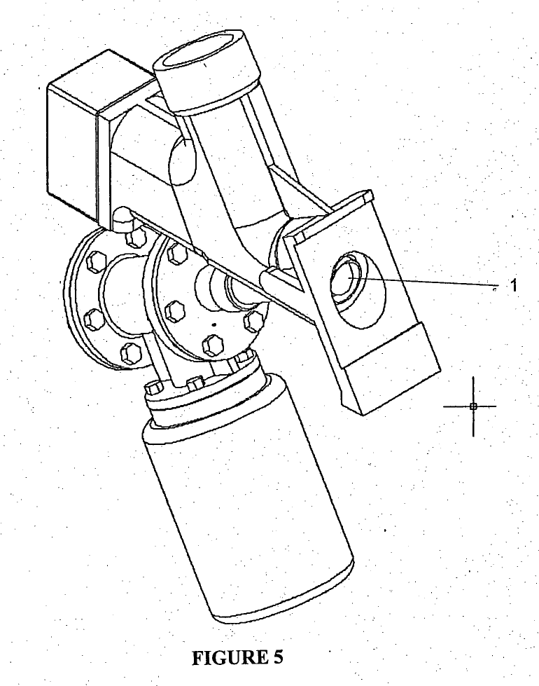

FIG. 6: corresponds to a perspective bottom view of the injection system of air impacts from the present invention.

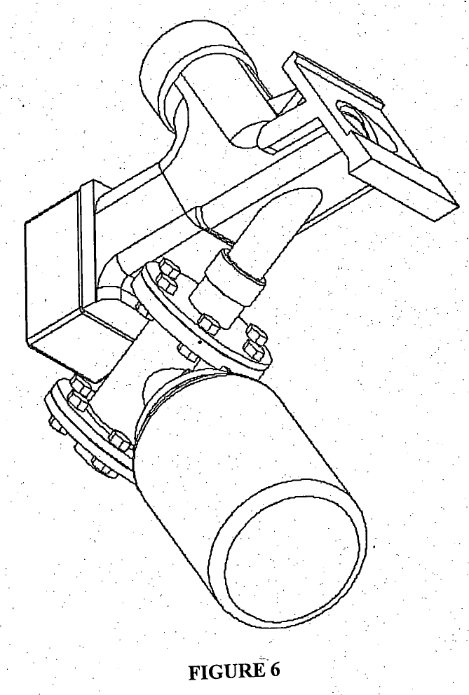

FIG. 7: corresponds to a perspective view, seen from back and from top, but from the other side respect to that shown in the FIG. 5, of the injection system of air impacts from the present invention.

FIG. 8: corresponds to a perspective view of a series of injection systems of air impacts, placed on multiple nozzles in a standard converter or reactor.

### DETAILED DESCRIPTION OF THE INVENTION

The invention is a system and method intended to unblock the air or gas blow nozzles of reactors or fusion coverters in the pyrometallurgy of mining industry using the injection of discrete air impacts, regulated to high pressure and rate, through the enriched air blow nozzles in reactors or pyrometallurgical converters.

The method consists in the injection of high pressure and rate air impacts through a nozzle (1) using a system formed by an accumulator (2) that storages the compressed air to be injected in the form of impacts through the nozzle (1). The compressed air is storaged in the accumulator (2) ta pressure ranged between 70 and 100 psi (4.82 and 6.89 bar). For such an effect, the accumulator (2) has a capacity ranging between 40 and 60 liters of air, which will depend of the pressure wanted for the performance of the impact. In the following table is observed the pressure associated to the storaged volumen in order to achieve this pressure:

| Pressure in bar (psi) | Volume in liters |
|---|---|
| 4.82 (70) | 42 |
| 5.17 (75) | 45 |
| 5.65 (80) | 48 |
| 5.86 (85) | 51 |
| 6.20 (90) | 54 |
| 6.55 (95) | 57 |
| 6.89 (100) | 60 |

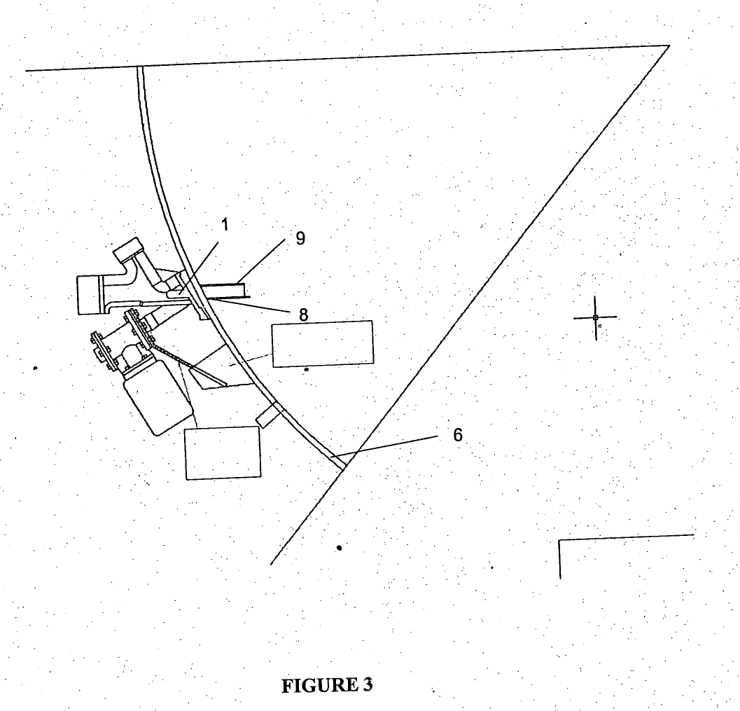

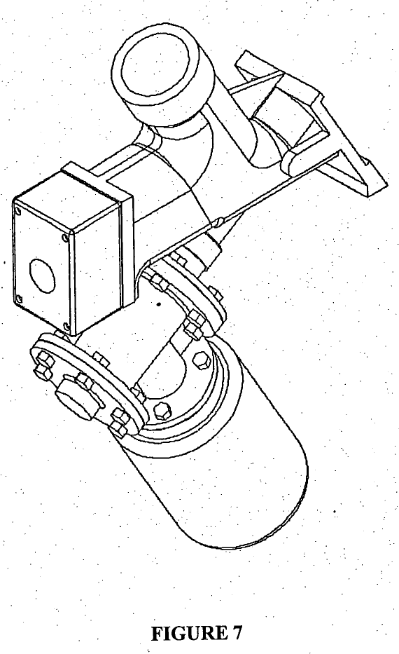

Over the accumulator it is added a piston valve (3) intended to evacuate, in a split second, preferentially 0.09 s, all the air contained in the accumulator (2). The valve (3) in turn is connected from one of its sides to the lower part of the tube which is part of the nozzle (1). This connection is performed through the tube (4) which have a diameter equal or lesser than that of the tube which is part of the nozzle (1). Therefore, when the air contained in the accumulator (2) is released by the activation of the valve (3), the compressed air enters directly to the nozzle (1) at the same pressure which it was released from the accumulator, i.e., between 4.82 and 6.89 bar. From the FIGS. 3 and 7, it is possible to observe that the entry to the nozzle (1) occurs ahead the access (5) of enriched air to normal pressure, 20 psi (1.38 bar), and adjacent to the casing (6) of reactor for producing the reaction in the melting bath, inside the reactor.

When the air impact is injected from the accumulator (2), two effects or physical phenomena occur: the Venturi effect and the Coanda effect. The first sets that the air impact pulls the enriched air to normal pressure, i.e., produces the suction of it, helping it flows towards the inside of reactor. The second effect produces that the flow of the high pressure air impact remains in the direction of the flow and close to the lower part of the wall of nozzle (1) tube. This effect produces the breaking of the obstructive accretion (7) deposited in the lower part of the nozzle, at the entrance of reactor. Accordingly, these principles inhibit the production of an obstructive accretion, allowing a continuous flow of enriched air towards the inside of the melting bath.

On the other hand, the connection angle (α) between the tube (4) and the nozzle (1) ranged from 140° to 160°, preferentially 150°. This angle (α) allows the air can run effectively through the nozzle (1) and not hit on the wall of it.

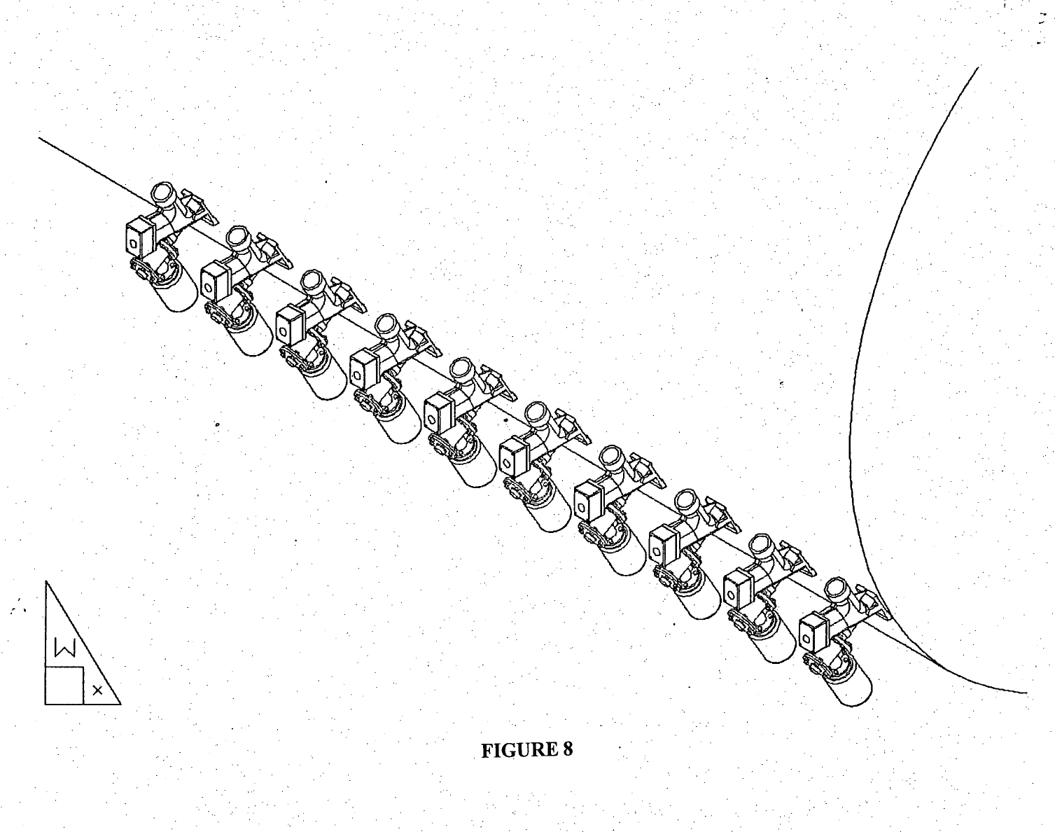

The piston valve (3) is commanded by a solenoid controlled valve (not shown in the figures) which is commanded by a timer or programmable PLC in order to define the times and sequences of air impact injections. This means, in fact, that a massive use in a nozzle line placed in a converter, as it is shown in the FIG. 8, can define sequentially a frequency of air impact injections for influencing the surge into the melting bath, which will improve the melting kinetics.

Alternatively, the system can have a flow measure device in the nozzle (1) in order to perform the air impact when the order from an actuator is received, e.g., a PLC, depending from the measure device, for releasing its contents when the normal air flow which should circulate for the nozzle decreases respect to a pre-established value. The measure device should be preferentially an optical sensor which be able to observe if the nozzle (1) is blocked. If an obstruction is observed, this sensor emits a signal towards an actuator, e.g. the PLC, which drive the valve (3) allowing the injection of the air impact which will remove the accretions that are obstructing the nozzle (1).

When the air impact is performed through the nozzle, the effect of the rate is extremely relevant because such a rate, associated with the pressure of the air, will define the penetration length of the air in the inside wall of the converter, from the inside end (8) of nozzle (1) to the melting bath. However, this will depend on the density of gas respect to the melting liquid and, in turn, to the Froude number, which is the travel that the gas makes into the liquid forming the melting bath.

According to an empirical relation for converters, developed by Hoefele and Brimacombe in 1994, the penetration of a gas in a liquid is given by the following equation:

$${x}_{c} = 10.7 {{Fr}^{0.92} ( \frac{{ρ}_{g}}{{ρ}_{l}} )}^{0.35} {d}_{t} , where \text{:}$$

ρ_{g}: gas density

ρₗ: liquid density

dₜ: nozzle diameter

In turn, the Froude number, Fr, is defined as follows:

$$Fr = \frac{{V}_{g}}{\sqrt{g ( \frac{{ρ}_{l}}{{ρ}_{g}} - 1 ) {d}_{t}}} ,$$

, where V_{g}: gas rate at the exit of nozzle.

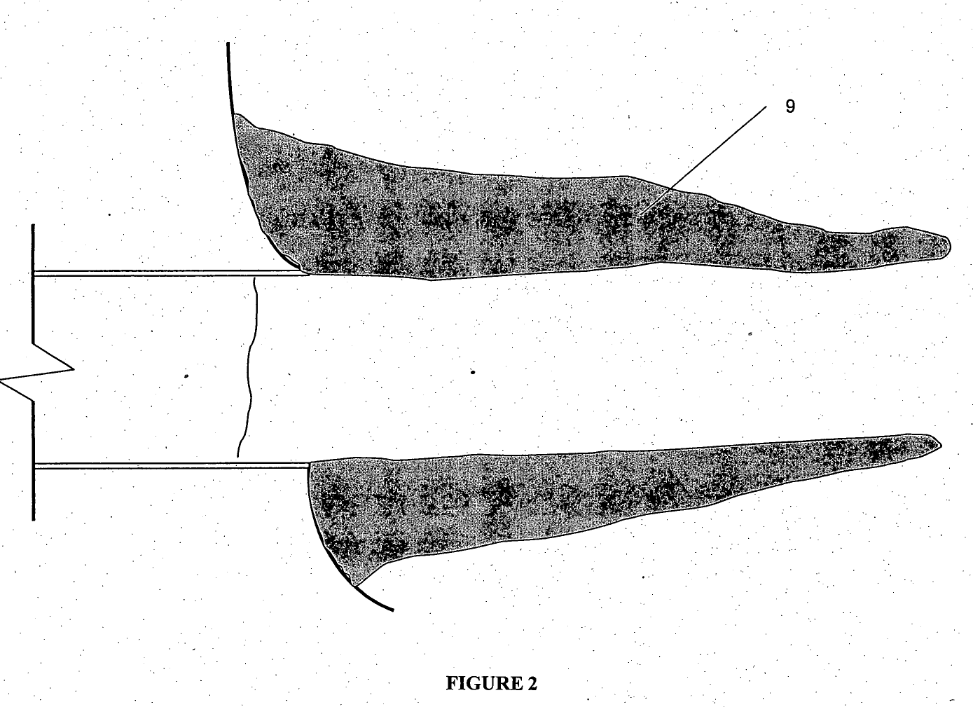

This means that the air impact which enters into the melting bath will produce a cooling of the melting bath in the extent of its penetration, beginning the formation of the directed accretion (9), as shown in the FIG. 2, from the bath material which it is solidified due to the before mentioned cooling. Definitely, this effect produces a natural lengthening of the tube which is part of the nozzle (1), from the inner wall of rector.

The natural lengthening of the tube which is part of the nozzle (1), produced by the directed accretion (9), makes that the enriched air which is usually blowed by the nozzle (1) enters deeper into the melting bath, travelling a distance that ranges between 11 and 22 cm, approximately. Because of this distance of penetration, the enriched air enters to a longer distance from the reactor or converter wall and, consequently, to a longer distance from the refractory material of it, in a zone where the bath surge already exists, preventing the occurrence of obstructive accretions (7) since the very surge will tend to eliminate them. Therefore, it is produced a combination between the surge and the high pressure and rate air impact.

As it was already shown, the rate associated to the pressure has a basic role in the formation of the directed accretion. This rate ranges from 263 to 328 m/s at the exit of the piston valve (3) when the air impact is produced, and arrives to the nozzle (1) with a rate which ranges from 195 to 300 m/s.

The examples presented below show the results obtained with the application of the air impact and its incidence in the distance of penetration into the bath.

Calculation of the Froude number for the different operation states:

The calculation of Froude number is performed from the density ratios

$$\begin{matrix}Ratio \frac{{ρ}_{g}}{{ρ}_{l}} & 0 \text{,} 000233 & 0 \text{,} 000257 \\ \frac{ {ρ}_{ g}}{ {ρ}_{ l}} = 4291 , 85 & 3891 , 05 & \end{matrix}$$

Diameter of entrance dₑ=0.116 m Diameter in the linking pipe from Tube (4) to Nozzle (1) Inner diameter Nozzle d, =0.059 m. Inner diameter of nozzle.

Calculation of the exit rate in normal regime to 20 psi (1.38 bar):

With the following parameters of a CPS converter:

| | | | |
|---|---|---|---|
| Q = | 750 | Nm3/min | |
| Q = | 0.227 | Nm3/s | Volume of oxigen-enriched air |
| Vc = | 21.51 | m/s | Rate in the feeding pipe |
| V_{g} = | 83.129 | m/s | Rate in the nozzle exit |

Calculation of the Froude number for the normal state:

$$\begin{matrix}\text{Ratio} \frac{{ρ}_{g}}{{ρ}_{l}} & 0 \text{,} 000233 & 0 \text{,} 000257 & \\ Fr = 1 , 67 & 1 , 75 Froude number for the normal state . & & \\ {x}_{c} / {d}_{t} = 0 , 92 & 0 , 99 \begin{matrix}Empirical ratio for the air \\ penetration into the liquid\end{matrix} & & \end{matrix}$$

Therefore, the travel of the air in the bath is:

x_{c}=54.1 58.6 mm Travel of the air in the bath, in mm.

Calculation of the exit rate with the air impact system using a pressure of 80 psi (5.52 bar)

Rate in the system c=263,137 m/s Rate in the exit of the air impact system Rate in the nozzle tube V_{g}=195,076 m/s Rate in the exit of the nozzle tube

Calculation of the Froude number for the state with the air impact system:

$$\begin{matrix}Ratio \frac{{ρ}_{g}}{{ρ}_{l}} & 0 \text{,} 000233 & 0 \text{,} 000257 & \\ Fr = 3 , 91 & 4 , 11 \begin{matrix}Calculation of the Froude number for \\ the state with the air impact system\end{matrix} & & \end{matrix}$$

Therefore, the values of the empirical ratio for the air penetration are

x_{c}/dₜ=2.01 2.18 Empirical ratio for the air penetration into the liquid

Therefore, the travel of the air in the bath is equal to:

x_{c}=118.6 128.4 Travel of the air in the bath, in mm.

Calculation of the exit rate with the air tube using a pressure of 100 psi (6.89 bar)

Rate in the system c=328,921 m/s Rate in the exit of the air impact system Rate in the nozzle tube V_{g}=243,846 m/s Rate in the exit of the nozzle tube

Calculation of the Froude number for the state with the air impact system:

$$\begin{matrix}Ratio \frac{{ρ}_{g}}{{ρ}_{l}} & 0 \text{,} 000233 & 0 \text{,} 000257 & \\ Fr = 6 , 60 & 6 , 93 \begin{matrix}Froude number for the \\ state with air impact system\end{matrix} & & \end{matrix}$$

Therefore, the values of the empirical ratio for the air penetration are:

x_{c}/dₜ=3.25 3.52 Empirical ratio for the air penetration into the liquid

Therefore, the travel of the air in the bath is equal to:

x_{c}=191.8 207.6 Travel of the air in the bath, in mm.

1. A method of unblocking enriched air blow or reaction gas nozzles in reactors or fusion converters in mining industry or pyrometallurgy, comprising injecting discrete air impacts through the enriched air blow or reaction gas nozzles; said air impacts penetrating into a melting bath of such reactors or converters, breaking blocking accretions that clog the flow of enriched air or gas through the nozzle and forming, a directed accretion with material of the melting bath solidified by the cooling effect, whereby the production of directed accretion be a natural lengthening of the tube of nozzle from the inner wall of these reactors or converters, and by this way to allow that the O2-enriched air blowing through the nozzle penetrates in the melting bath, to a distance where breaking waves of this flow are generated at a sufficient distance from a wall of refractory material to reduce erosion of the refractory material and reduce obstructive accretions.

2. A method according to claim 1, wherein air impacts are injected at a pressure of 70 to 100 psi.

3. A method according to claim 1, wherein air impacts are injected at a rate of 195 to 300 m/s.

4. A method according to claim 1, wherein air impacts are injected at one second intervals.

5. A method according to claim 1, wherein the air impact, draws enriched air or reaction gas towards a melting bath.

6. A method according to claim 1, wherein air impacts are injected in multiple nozzles placed in such converters or reactors so as to define sequentially a frequency of injection effecting a surge generated into a melting bath, whereby melting kinetics are improved.

7. A method according to claim 1, wherein enriched air penetrates a distance of 11 to 22 μm, due to lengthening of tube ranges from 11 to 22 cm.

8. A system unblocking enriched air or reaction gases blow nozzles in reactors or fusion converters used in mining or pyrometallurgy, comprising an accumulator for storage of compressed air, and a valve capable of evacuating air contained in the accumulator, at the same pressure at which the air is contained inside of the accumulator, said valve being fitted by one side to a lower part of a tube forming part of said nozzle, ahead of an access point of enriched air to such a nozzle said accumulator and valve being capable of injecting air impacts through said nozzle.

9. A system according to claim 8, wherein said valve is connected to a lower part of said tube forming part of the nozzle is found in an angle between 140° and 160°.

10. A system according to claim 9, wherein the valve is connected at an angle of 150°.

11. A system according to claim 8, wherein the valve is controlled by a solenoid and a timer or programmable PLC capable of defining times and sequences of injection of air impacts.

12. A system according to claim 8, wherein the accumulator has a capacity to store 40-60 liters of compressed air.

13. A system according to claim 12, wherein compressed air is stored in the accumulator at a pressure of 70 to 100 psi (4.82 and 6.89 bar).

14. A system according to claim 13, wherein a given storage volume in the accumulator has a pressure according to the following table:

| Pressure in psi | Volume in liters |
|---|---|
| 70 | 42 |
| 75 | 45 |
| 80 | 48 |
| 85 | 51 |
| 90 | 54 |
| 95 | 57 |
| 100 | 60 |

15. A system according to claim 8, comprising a plurality of nozzles placed on the reactor or converter, capable of defining a sequence of injection of air impacts influencing surge in a melting bath.

16. according to claim 8, wherein compressed air can be ejected from the accumulator at 263 to 328 m/s.

17. A system according to claim 8, in which compressed air reaches the nozzle at 195 to 300 m/s.

18. A system according to claim 8 having a flow measuring device in the nozzle effecting the air impact on an order to an actuator when normal air flow for a nozzle decreases with respect to a pre-established value.

19. A system according to claim 18, wherein the measuring device is an optical sensor which is able to observe if the nozzle is blocked.

20. A method according to claim 1, wherein air impacts are injected at 0.09 second intervals.

21. A system according to claim 16, wherein the sequence is controlled by such a timer or programmable PLC.

22. A system according to claim 18, wherein the actuator issues an order to effect the air impact.
